(19) United States
(12) Patent Application Publication
(10) Pub. No.: US 2017/0238146 A1
(43) Pub. Date: Aug. 17, 2017

(54) Systems and Methods for Improving Indoor Position Detection

(71) Applicant: aisle411, Inc., St. Louis, MO (US)

(72) Inventors: Matthew Kulig, Milstadt, IL (US); Nathan Pettyjohn, St. Louis, MO (US); Dante Cannarozzi, St. Louis, MO (US); Niarcas Jeffrey, St. Louis, MO (US)

(21) Appl. No.: 15/434,306

(22) Filed: Feb. 16, 2017

Related U.S. Application Data
(60) Provisional application No. 62/295,837, filed on Feb. 16, 2016.

(51) Int. Cl. H04W 4/04

(52) U.S. Cl. CPC H04W 4/04

(57) ABSTRACT

Systems and methods which provide a uniform interface into indoor positioning systems. The systems and methods receive multiple indoor position data sets from multiple indoor positioning systems, filter the various data sets for each system to identify the most accurate or reliable position as determined by each system, and calculate a refined indoor position, based upon the filtered positions, which is then returned as the indoor position of the device in question. The returned value can be provided in a client-server architecture, via an API, or both.

### CROSS-REFERENCE TO RELATED APPLICATIONS

This application claims benefit of U.S. Provisional Application No. 62/295,837, filed Feb. 16, 2016, the entire disclosure of which is incorporated herein by reference.

### BACKGROUND

1. Field of the Invention

This disclosure pertains to the field of indoor positioning, and more particularly to locating a user device in an indoor location using a plurality of indoor positioning systems.

2. Description of the Related Art

In the field of indoor positioning systems, the locations of objects or people are generally tracked inside a building using various technologies, including radio waves, magnetic fields, acoustic signals, light, or other information collected by or from hardware devices, usually mobile devices carried by or attached to the objects or people tracked. Such mobile devices may be a mobile phone or smart phone, a wearable computing device, or an RFID tag or other tracking element.

Most indoor positioning systems operate in similar fashion. Generally, the positioning system uses transmitters to communicate wirelessly with a tracked device. The positioning system either provides position data directly through such communications (such as global positioning satellite systems), or a position for the device can be inferred from the transmissions (such as with short-range radio technologies like WiFi and BlueTooth). Technologies using this technique include GPS, WiFi, BlueTooth, beacons, and visible light and acoustic systems. Other technologies use a “fingerprinting” technique, where sensors associated with the client device itself are capable of generating position-specific data. In such technologies, a library of “fingerprints” is developed for a location by taking measurements at various positions and comparing such measurements to newly-captured measurements from user devices to estimate position. Such technologies include magnetic fingerprinting systems. In certain embodiments, these techniques may be combined to improve accuracy, notably with WiFi.

Regardless of how the indoor positioning technology works, each system generally provides an application programming interface by which application developers can access the position data determined by the indoor positioning system. For some systems, this is done using system calls or other operating system-level interfaces. For example, position data from the GPS receiver in a mobile phone is typically accessible through the operating system.

For other systems, a software library provides the position data, often because the hardware technology utilized is designed for another purpose and is being used for indoor positioning as a secondary use, such as WiFi. The application programming interface then makes available the indoor position data determined by the hardware systems.

Typically, since indoor position can change quickly, updated position data is available frequently. The frequency of updates may be a constant (e.g., position data is updated n times per second), or may change over time (e.g., if the position data does not materially change after some predefined amount of time, updates are provided less frequently, or not at all, until the position changes).

Although there are many commercial indoor positioning systems available, there is no commercially-accepted standard for such systems. This means each system implements its own independent interface and generates location data in its own independent format. Not all systems provide the same information, or provide information in the same format or at the same frequency. This means that an application developer desiring to utilize positioning data generated by these systems must build application logic for each system. This imposes significant costs and overhead.

Further, it becomes difficult to build an application generically for multiple locations, as each location may implement different indoor positioning technologies, which may in turn require the application to be customized for specific locations. Further, indoor positioning technology is rapidly advancing and changing and, when new technologies emerge, prior applications must be updated to implement new interlaces. Similarly, old technologies may be retired, fall out of favor, or prove vulnerable to attack, requiring that the old technologies be removed from the application. Also, existing interfaces may change, which may require applications using such technologies to be continually updated to keep up with interface and operational changes.

Further, not all indoor positioning technologies are the same. Each has strengths and weaknesses that may make a given technology suitable for certain uses but not others. For example, GPS may be reasonably accurate on the roof of a highrise building but not on the ground floor of that same building. Low-energy beacons may be highly accurate if the user is very close to them, allowing for pinpoint locations within a small radius. Magnetic fingerprinting may be n ore accurate in open spaces with layouts that do not frequently change. Each indoor positioning technology also has weaknesses. For example, all radio wave-based, technologies are vulnerable to interference from the presence of people, as the human body consists of a large amount of water, a known radio wave absorber.

What is needed in the art is a uniform interface which provides an indoor location position based on data provided by a plurality of available indoor positioning systems, using, the strengths of each system to cover and account for the weaknesses of the others.

### SUMMARY OF THE INVENTION

The following is a summary of the invention which should provide to the reader a basic understanding of some aspects of the invention. This summary is not intended to identify critical components of the invention, nor in any way to delineate the scope of the invention. The sole purpose of this summary is to present in simplified language some aspects of the invention as a prelude to the more detailed description presented below.

Because of these and other problems in the art, described herein, among other things, is a method comprising: providing a user device; providing a plurality of indoor positioning systems, each supplying a plurality of indoor positioning, datasets, each of the indoor positioning datasets comprising indoor position data for a position of the user device in an indoor location; receiving at the user device from each indoor positioning system the plurality of indoor positioning datasets supplied by the each indoor positioning system; identifying a plurality of filtered positions by, for each of the indoor positioning systems, filtering the received plurality of indoor positioning datasets supplied by the each indoor positioning system to identify a filtered position for the user device, the filtered position being a determined highest quality available indoor position for the user device in the received plurality of indoor positioning datasets supplied by the each indoor positioning system; and calculating a refined indoor position for the user device, the relined indoor position being calculated based at least in part based on the identified plurality of filtered positions.

In an embodiment, at least one indoor positioning system in the plurality of indoor positioning systems is selected from the group consisting of: a WiFi system, a global positioning system, a short-range low-energy beacon system, a visible light-based location system, an acoustic location system, and a magnetic field-based location system.

In an embodiment, the identifying step and the calculating step are performed at the user device.

In an embodiment, the method further comprises: providing a computer server; receiving at the computer server the received pluralities of indoor positioning datasets supplied by the each indoor positioning system; performing the identifying step and the calculating calculating step at the computer server; receiving at the user device tie refined indoor position.

in an embodiment, the user device is selected from the group consisting of a mobile computer, a tablet computer, a laptop computer, a mobile phone, a smart phone, and a wearable computing device.

In an embodiment, the indoor position data for a user device includes one or more of: an altitude of the user device; an identifier of the floor of a building on which the user device is located; a timestamp indicative of when each the indoor position data was determined or received; direction, orientation, or heading data for the user device; an accuracy measure; and a signal strength indicator.

In an embodiment, the indoor position data includes a timestamp and the each filtered position in the plurality of filtered positions is determined at least in part based on comparing the timestamps to determine the most recent indoor position data for the each indoor positioning system.

In an embodiment, the indoor position data includes an accuracy measure and the each filtered position in the plurality of filtered positions is determined at least in part based on comparing the accuracy measures to determine a most accurate indoor position data for the each indoor positioning system.

In an embodiment, the refined indoor position is calculated in part based on historical accuracy data for each indoor positioning system in the plurality of indoor positioning systems.

Also described herein, among other things, is a system comprising: a user device comprising a microprocessor and a non-volatile computer-readable medium having computer-readable program instructions; a plurality of indoor positioning systems, each supplying a plurality of indoor positioning datasets, each of the indoor positioning datasets comprising indoor position data for a position of the user device in an indoor location; wherein the computer-readable program instructions, when executed by the microprocessor, cause the user device to perform the steps of: receiving from each indoor positioning system the plurality of indoor positioning datasets supplied by the each indoor positioning system; identifying a plurality of filtered positions by, for each of the indoor positioning systems, filtering the received plurality of indoor positioning datasets supplied by the each indoor positioning system to identify a filtered position for the user device, the filtered position being a determined highest quality available indoor position for the user device in the received plurality of indoor positioning datasets supplied by the each indoor positioning system; and calculating a refined indoor position for the user device, the refined indoor position being calculated based at least in part based on the identified plurality of filtered positions.

In an embodiment, at least one indoor positioning system in the plurality of indoor positioning systems is selected from the group consisting of a WiFi system, a global positioning system, a short-range low-energy beacon system, a visible light-based location system, an acoustic location system, and a magnetic field-based location system.

In an embodiment, the user device is selected from the group consisting of: a mobile computer, a tablet computer, a laptop computer, a mobile phone, a smart phone, and a wearable computing device.

In an embodiment, the indoor position data for a user device includes one or more of: an altitude of the user device; an identifier of the floor of a building on which the user device is located; a timestamp indicative of when each the indoor position data was determined or received; direction, orientation, or heading data for the user device; an accuracy measure; and a signal strength indicator.

In an embodiment, the indoor position data includes a timestamp and the each filtered position in the plurality of filtered positions is determined at least in part based on comparing the timestamps to determine the most recent indoor position data for the each indoor positioning system.

In an embodiment, the indoor position data includes an accuracy measure and the each filtered position in the plurality of filtered positions is determined at least in part based on comparing the accuracy measures to determine a most accurate indoor position data for the each indoor positioning system.

In an embodiment, the refined indoor position is calculated in part based on historical accuracy data for each indoor positioning system in the plurality of indoor positioning systems.

Also described herein, among other things, is a system comprising: a computer server comprising a microprocessor and a non-volatile computer-readable medium having computer-readable program instructions; a plurality of indoor positioning systems each supplying a plurality of indoor positioning datasets, each of the indoor positioning datasets comprising indoor position data for a position of a user device in an indoor location; wherein the computer-readable program instructions, when executed by the microprocessor, cause the computer server to perform the steps of: receiving via a telecommunications network a plurality of indoor positioning datasets supplied by each indoor positioning system; identifying a plurality of filtered positions by, for each of the indoor positioning systems, filtering the received plurality of indoor positioning datasets supplied by the each indoor positioning system to identify a filtered position for the user device, the filtered position being a determined highest quality available indoor position for the user device in the received plurality of indoor positioning datasets supplied by the each indoor positioning system; and calculating a refined indoor position for the user device, the refined indoor position being calculated based at least in part based on the identified plurality of filtered positions.

In an embodiment, the indoor position data includes a timestamp and the each filtered position in the plurality of filtered positions is determined at least in part based on comparing the timestamps to determine the most recent indoor position data for the each indoor positioning system.

In an embodiment, the indoor position data includes an accuracy measure and the each filtered position in the plurality of filtered positions is determined at least in part based on comparing the accuracy measures to determine a most accurate indoor position data for the each indoor positioning system.

In an embodiment, the refined indoor position is calculated in part based on historical accuracy data for each indoor positioning system in the plurality of indoor positioning systems.

### BRIEF DESCRIPTION OF THE DRAWINGS

FIG. 1 is a schematic diagram of an indoor location using an embodiment of the systems and methods according to the present disclosure.

FIG. 2 is a flow chart showing an embodiment of the systems and methods according to the present disclosure.

FIG. 3 is a high-level logical diagram of an embodiment of the systems and methods according to the present disclosure.

FIG. 4 is a more detailed logical diagram of an embodiment of the systems and methods according to the present disclosure.

### DESCRIPTION OF THE PREFERRED EMBODIMENT

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and apparatus. As various changes could be made in the above constructions without departing from the scope of the disclosures, it is intended that all matter contained in the above description or shown in the accompanying drawings shall be interpreted as illustrative and not in a limiting sense.

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, smart phones, tablet computers, mobile devices, server farms, hardware appliances, minicomputers, mainframe computers, video game consoles, handheld video game products, and wearable computing devices including but not limited to eyewear, wristwear, pendants, fabrics, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that: some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory.

Throughout this disclosure, terms used herein to describe or reference media holding software, including without limitation terms such as “media,” “storage media,” and “memory,” may include or exclude transitory media such as signals and carrier waves.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network.

Throughout this disclosure, the term “transmitter” refers to equipment, or a set of equipment, having the hardware, circuitry, and/or software to generate and transmit mechanical or electromagnetic waves carrying messages, signals, data, or other information. A transmitter may also comprise the componentry to receive electric signals containing such messages, signals data, or other information, and convert them to such electromagnetic waves. The term “receiver” refers to equipment, or a set of equipment, having the hardware, circuitry, and/or software to receive such transmitted electromagnetic waves and convert them into signals, usually electrical, from which the message, signal, data, or other information may be extracted. The term “transceiver” generally refers to a device or system that comprises both a transmitter and receiver, such as, but not necessarily limited to, a two-way radio, or wireless networking router or access point. For purposes of this disclosure, all three terms should be understood as interchangeable unless otherwise indicated for example, the term “transmitter” should be understood to imply the presence of a receiver, and the term “receiver” should be understood to imply the presence of a transmitter.

Throughout this disclosure, the term “beacon” generally refers to short-range wireless transmitters communicating with nearby devices using a wireless communications protocol. Such transmitters generally use short-wavelength protocols, such as the IEEE 802.15 family of protocols or commercial successors thereto. However, in certain embodiments, a beacon may include devices using other wireless protocols, such as the IEEE 802.11 protocols or commercial successors thereto. Examples of such devices include Bluetooth transmitters and Bluetooth low energy “BLE”) transmitters, including but not necessarily limited to a Motorola® MPact™ device and/or an Apple® iBeacon® device. It will be appreciated by one of ordinary skill in the art that this term, as used herein, is not limited to BLE devices, but rather may include all functionally similar wireless transmitters.

Described herein, among other things, are systems and methods for determining an indoor position of a receiver based upon data received from a plurality of independent indoor location transmitters (or other equivalent technology, such as magnetic fingerprints).

At a high level, the systems and methods comprise receiving a plurality of indoor positioning datasets from a plurality of generally commercially and technologically independent indoor positioning systems, filtering the plurality of data sets received from each to identify a highest quality available position dataset for each system (known as the“filtered position” herein), and calculating a refined indoor position based upon the plurality of filtered positions. The refined position generally will not be a position actually received from any one system, but rather a determined position based on various factors. The systems and methods might be best understood with reference to non-limiting illustrative examples.

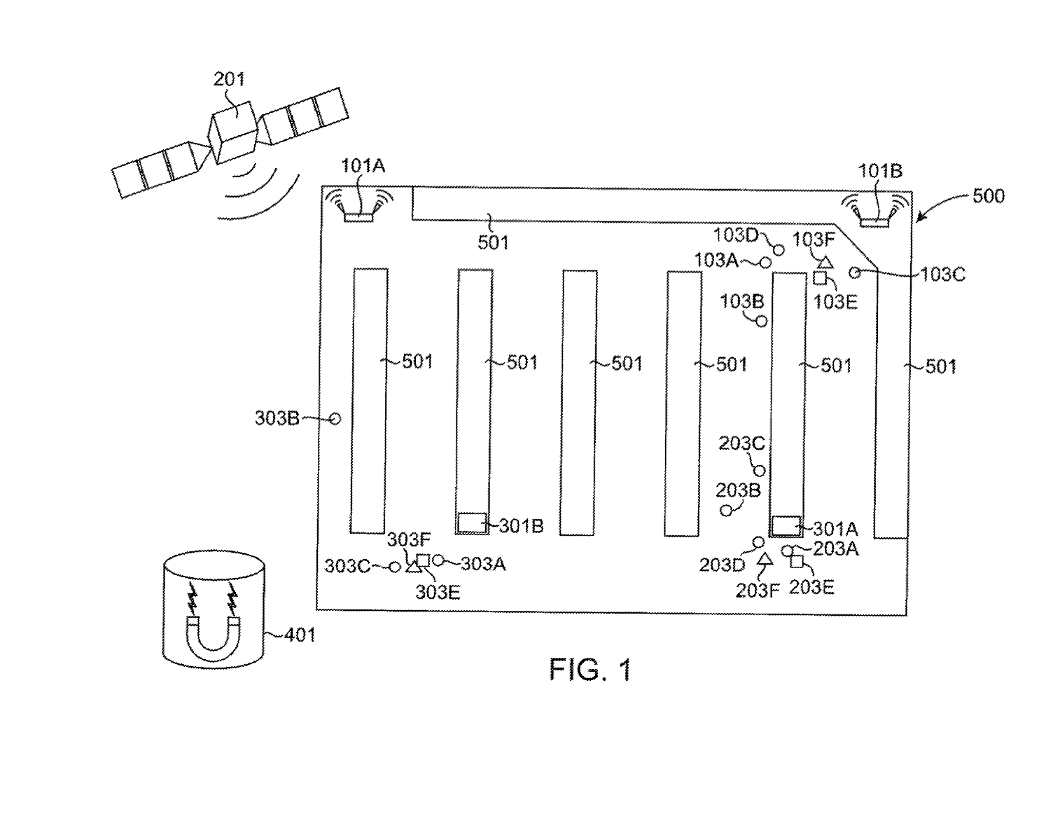

Referring to FIG. 1, a schematic diagram of an indoor location (500) is depicted in which a plurality of indoor positioning systems (101), (201), (301) and (401) are deployed. In the depicted embodiment of FIG. 1, the location (500) is a retail store with a plurality of merchandizing fixtures (501) disposed therein. A first indoor positioning system (101) is deployed in the location (500). The depicted first indoor positioning system (101) comprises a set of wireless networking devices (101A) and (101B), such as, but not necessarily limited to, wireless routers (101A) and (101B) and/or wireless access points (101A) and (101B). A first such wireless networking device (101A) is disposed in a first position in the indoor location (500) and a second wireless networking device (101B) is disposed in a second position in the indoor location (500).

This first indoor positioning system (101) may be used to determine or estimate a position of a user device in the indoor location (500). By way of example and not limitation, suppose a user device is at a position (103E) near a wireless networking device (101B). The first indoor positioning, system (101) may provide an estimated indoor position (103A) for the user device. This estimate most likely will not completely coincide with the actual position (103E) of the device, due to inherent deficiencies in use of wireless networking devices (101A) and (101B) in their respective detecting positions. However, in this illustrative example, because the user device's actual position (103E) is near one of the wireless networking devices (101B), the position determined (103A) by the wireless networking device (101B) is proximate to the true position (103E).

The user device is generally a mobile computer, which may include other components as well. Examples of user devices include, without limitation, a mobile computer, a tablet computer, a laptop computer, a mobile phone, a smart phone, a wearable computing device, and so forth. The user device is typically an end-user device carried by a shopper or customer for the indoor location (500), but may in some circumstances be more specialized systems specific to a given location, such as a computer-on-wheels in a health care setting.

Continuing the illustrative example, a second indoor positioning system (201) may be used to determine or estimate a second position (1038) for the user device. In this illustrative example, the second indoor positioning system (201) is a global positioning system (201) using orbital satellites. Due to interference caused by the root of the structure, the GPS system (201) determines a position (103B) that may be less accurate than the position (103A) determined by the first indoor positioning system (103A), or may provide only a “last known” position reflecting the last detected location of the receiver outside of the store, when the satellite was accessible.

In the depicted embodiment of FIG. 1, the user device receives indoor positioning data from both indoor positioning systems (101) and (201). The nature of the data received from each system (101) and (201) may differ. For example, GPS systems (201) typically provide a position using a global coordinate system, such as latitude and longitude. However, a WiFi system (101) has a shorter range, has no need of global coordinates, and is more likely to provide an (x,y) coordinate set as an offset from an origin, similar to two-dimensional Cartesian graphs. The origin may be the position of a wireless networking device ((101A) or (101B)) or another predefined origin point in or near the indoor location (500). Still other systems may provide the indoor position in another coordinate system, as using polar, spherical, or ellipsoidal coordinate systems.

Other data may also be provided, in conjunction with the indoor position coordinates, including but not necessarily limited to; an altitude of the user device; the floor of the building; a timestamp indicative of when the indoor position coordinates were determined or received; a direction, orientation, heading, or other data concerning the disposition of the user device; an accuracy measure, such as a margin or percentage of error; and signal strength of the transmitter. All data received from a given indoor positioning system in connection with detecting an indoor position shall be referred to herein simply as “position data” for sake of clarity and simplicity.

It should be noted that this position data may be determined or provided by hardware systems external to the user device, hardware systems internal to the user device, and/or a combination of the two. For example, a GPS system (201) uses a GPS satellite to communicate with a GPS receiver in the user device and thereby to determine the device's location, using both an external system (the GPS satellite) and an internal hardware component (the OPS receiver). Other systems may also be involved in the process. For example, the GPS satellite (or the user device) may further communicate with a third system—a server, for example—which processes the satellite signal data and calculates a latitude and longitude, which is then provided to the user device.

Similarly, for the exemplar WiFi system (101), the user device comprises an internal receiver configured for sending and receiving wireless networking signals, and communicates with an external device (101B). However, in this case, the coordinates may be calculated or determined by internal components of the user device itself, such as by program instructions executed by the user device's microprocessor. Alternatively, the user device may communicate with a third system (e.g., a server) to provide the data needed to determine the coordinates, and receive the estimated coordinates from the third party system.

In any case, from the perspective of the application developer, position data is ultimately provided or made available in a dataset, generally via an API or SDK, comprising the above information. The particular combination of external and internal systems used to acquire or compute the data will necessarily vary not only from one indoor positioning system to the next, but may vary among different implementations of the same indoor positioning system. For example, one WiFi-based system may use a third party server, while another simply uses the microprocessor of the user device.

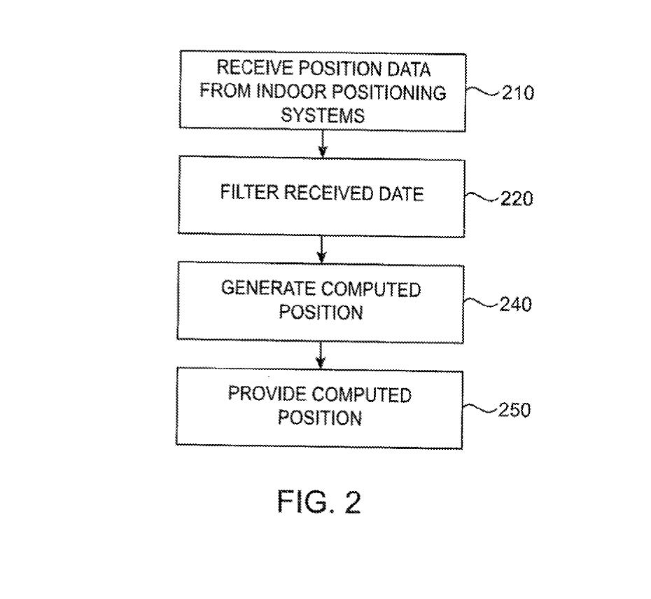

FIG. 2 depicts the method step (210) of receiving position data from a plurality of indoor positioning systems. It should be noted that the systems and methods described herein are generally described with respect to a plurality of indoor positioning systems and are designed and intended to operate using a plurality of indoor positioning systems. However, it is specifically contemplated that there may be instances in which, though not preferred, only one system is used. For example, where a store is beginning to implement a plurality of systems, only a single system may be available for a period of time. Likewise, if a second system is being decommissioned or is simply unavailable due to a technical problem, only one system may be available.

Typically, indoor positioning systems (101) and (201) provide position data at a frequency. This can mean that positions are updated (or updated data is available if requested) as fast as multiple times per second, or even, dozens or hundreds of times per second. Thus, in the depicted embodiment of FIG. 2, a plurality of position datasets are received (210) from each indoor positioning system. For each such indoor positioning system providing such datasets, the plurality of position datasets is filtered (220). The filtering step generally comprises selecting from among the plurality of position datasets the position dataset for the particular indoor positioning system determined to be the most accurate. This may be determined by, among other things, considering or comparing accuracy ranges, timestamps, or historical performance data for the particular indoor positioning system. This step is repeated for each indoor positioning system available, and results in a plurality of filtered position datasets. Preferably, this process ultimately results in a single “best” filtered position dataset for each indoor position system.

In an embodiment, the filtering step (220) comprises computing a confidence score or accuracy score for one or more of the position datasets. In a further embodiment, the filtering step (220) comprises selecting or identifying the position dataset having the highest or most reliable confidence score or accuracy score. In a still further embodiment, this step is repeated for each available indoor positioning system. The confidence score may be determined based upon, without limitation, one or more of the following, alone or in combination: reported accuracy, historical accuracy, aging, user feedback, or user-configured preferences.

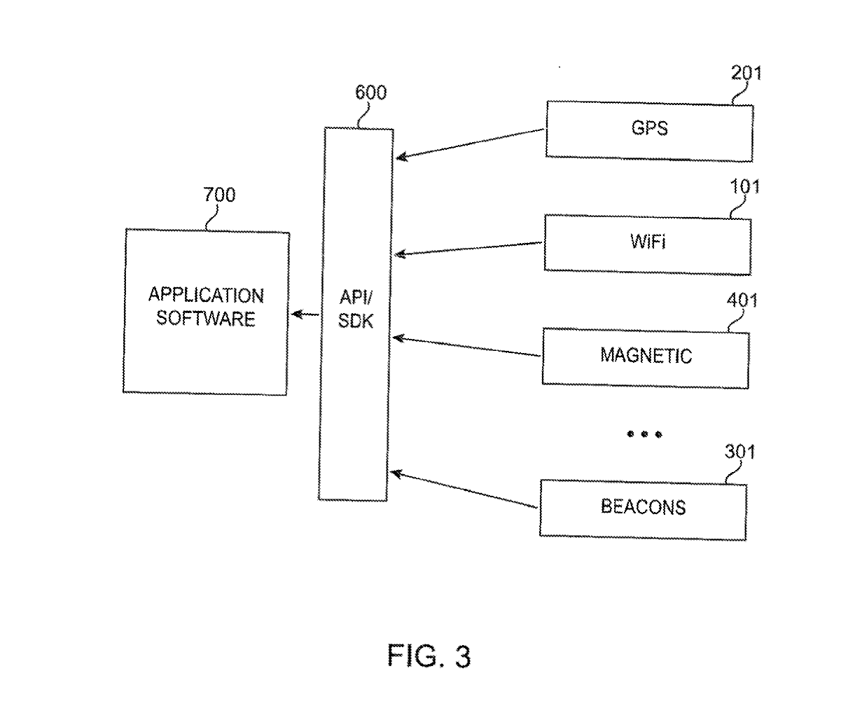

Next, the plurality of filtered position datasets are used to compute or calculate (240) a “refined” position, indicated as (103F) on FIG. 1. The “refined” position, while based upon the plurality of filtered position datasets, generally will not be the same position as any one of the filtered positions, but rather a calculated position. The calculation generally uses the strength of each indoor positioning system to provide a more accurate position than any of the individual systems. The refined position (103F) is then returned (250) or otherwise made available (250) to application software (700) via an interface (600). This structure is depicted in the logical diagram of FIG. 3, wherein a plurality of positions determined using a plurality of indoor position systems (101), (201), (301), . . . , (401) are filtered (220) and refined (240) according to the systems and methods described herein, and a refined position is provided (250) to application software (700) via an SDK or API (600). In embodiment, the interface (600) may also provide sonic or all raw indoor position data from one or more of the indoor positioning systems (101), (201), (301), . . . , (401).

This has multiple advantages over the prior art. First, application software (700) need only implement one interface (606), gaining access not only to the position data of each, but also the filtered and refined positions, which generally are more accurate than the raw position of any one individual system. Third, as indoor positioning systems are added to (or removed from) the location (500), little alteration of the application software is needed, as the relined position, which may thereafter be calculated using the newly deployed system, continues to be used at the application software (700) layer via the interface (600).

In an embodiment, the interface (600) further implements user-provided feedback. By way of example and not limitation, end-users may provide an indication of whether or how accurate a given refined position determination is. This data may in turn be used in future refined position calculation.

By way of example but not limitation, the user may be provided with an interface depicting a representation of the refined position of the user in the location (500). This may be, for example, a pindrop or arrow. The user may then manipulate the interface to indicate the user's true position, such as by tapping a displayed map of the location (500), or moving the visualization of the refined position to the real position. This user-provided position may then be retained and used in future calculations.

For example, if patterns emerge in the user-provided location data showing that one particular indoor positioning system has higher accuracy in a certain location, or a certain portion of a location, the refined calculation may favor position data received from that particular indoor positioning system.

Because different indoor positioning systems may use different coordinate systems, the systems and methods may further comprise a translation step. For example, this step may comprise translating global latitude and longitude to a local relative coordinate system (i.e., offsets from an origin point), or vice versa. In an embodiment where the systems and methods are used in conjunction with an indoor location mapping system, the received indoor position coordinates may be mapped to the coordinate system for the indoor location mapping system.

Another feature of the systems and methods is that they provide a single interface to all technologies usable for indoor positioning, whether such technologies are features of the underlying operating system or third party software packages or services. This also improves system portability, as the developer need not develop separate code for different operating systems.

Referring again to FIG, 1, in the depicted embodiment, additional indoor position systems may be used to generate the refined position. For example, a third indoor positioning system (301) comprising short-range low-energy beacon technology may be used. For true user device location (103E), the nearest beacon (301A) in the depicted embodiment is too far away to produce a useful location signal. However, where the user device is located (203E) proximate to the beacon (301A), the beacon (301A) may be more accurate (or perhaps the most accurate) indoor position system. In the depicted embodiment, the beacon (301A) generates an indoor position (203A) which is very near to the actual position (203E). Additionally, the WiFi indoor positioning system (101A) or (101B) may still provide a location (203B), but due to the distance between the true location (203E) and the transmitters (101A) and (101B), and the intervening merchandizing fixtures (501), this location (203B) is much less accurate. Similarly, the GPS system (201) may also generate a location (203C), which is also less accurate, due to the intervening building structure. In the depicted embodiment, a fourth system (401) using magnetic fingerprinting also provides a position (203D), which is closer than Will (101) or GPS (201).

As described herein, for each system (101), (201), (301) and (401), a plurality of position datasets is generally received and filtered to identify the position dataset with the highest confidence score, again generally by considering one or more of reported accuracy, historical accuracy, aging, user feedback, or user-configured preferences. These filtered “best” positions from each independent positioning system are then used to generate a refined position (203F). Again, the refined position (203F) is generally not a position actually reported by any one system (101), (201), (301) or (401), but rather is a determined or computed value.

In the depicted embodiment, refined position (203F) is actually less accurate than beacon position (203A). As described herein, users may indicate their true position, providing learning or training data to the system showing that the beacon'position (203A) should be favored. Over time, the refined position (203F) may weigh the beacon position (203A) more heavily for users whose positions are found to be within a certain range of the beacon. The range within which the beacon (301A) position (203A) is more accurate may likewise be developed and refined over time through user feedback and system learning/training, or may be determined and set through ordinary experimentation or user preferences.

Referring still to FIG. 1, a third illustrative example is provided for true user device position (303E). In this example, the user device position (303E) is again proximate to a beacon (301B), and the beacon-determined position (303A) is reasonably accurate. However, in this illustrative example, GPS position (303B) is very inaccurate. Further, the depicted embodiment, no position is available from the WiFi system (101), although a magnetic fingerprinting position (303C) is. In such circumstances, the outlier may simply be ignored or disregarded, as giving a major outlying data point any weight at all could bias the refined position (303E), and the outlying data point is deemed to have no value in computing the position.

It should be noted that, while WiFi (101), GPS (201), beacon (301), and magnetic fingerprinting (401) systems are depicted, the systems and methods described with reference to FIG. 1 are applicable to any technology usable for providing indoor position data for a user device. Technologies not yet developed may similarly be used, as may other currently available technologies.

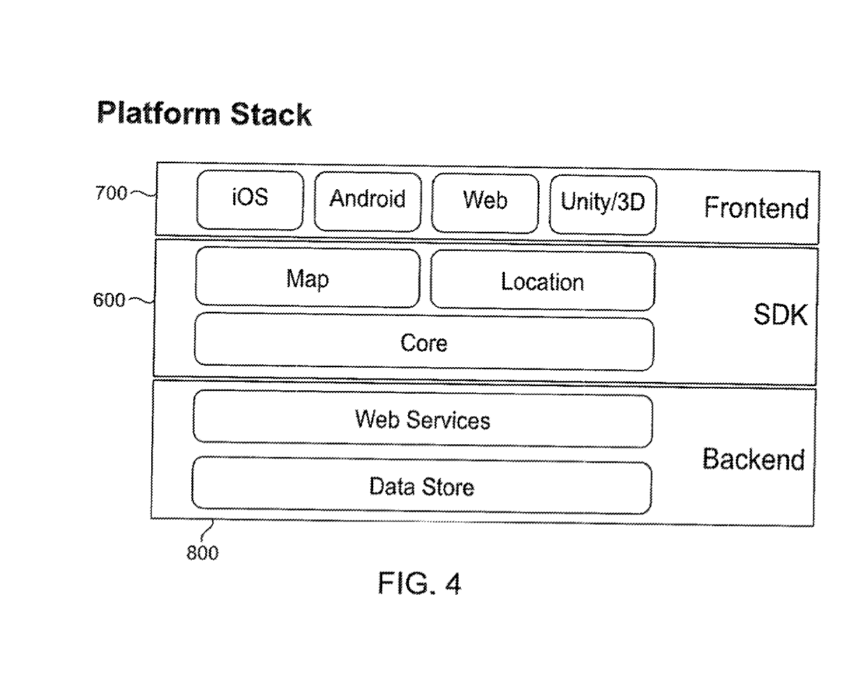

FIG. 4 depicts an embodiment of the system and methods in further detail. FIG. 4 is a logical schematic diagram of the system, comprising a backend (800), an interface (600), and application software (700). In the depicted embodiment, the interface (600) comprises a plurality of SDKs, but the systems and methods described herein could be implemented as a single SDK. In the depicted embodiment of FIG. 4, backend processing (800) is included. In such an embodiment, a client-server architecture may be implemented whereby indoor position is received from the plurality of indoor positioning systems at the user device, and then transmitted to a third system—generally a server—for processing and refining. This allows multiple user devices running application software to benefit from accumulated historical accuracy data without having to store or cache that body of data on the device itself, reducing resource consumption.

It will be understood by one of ordinary skill in the art that the term “indoor location” generally refers to an enclosed space, which may or may not be fully enclosed by a roof or ceiling, in which accurate, granular positioning data is used or needed. For example, baseball and football stadiums, even if not roofed, often experience inaccuracies in GPS-based location technologies alone. Similarly, outdoor locations such as flea markets may benefit from more refined and accurate positioning data than can be provided by GPS alone. Thus, terms such as “indoor location,” “indoor position,” and “indoor positioning system” should be understood as a term of art referring to the industry of determining accurate and granular positions, typically (but not exclusively) for indoor locations. It will also be understood that, while the non-limiting illustrative examples provided herein generally contemplate a retail space such as a store, the systems and methods described herein are suitable for use in any location in which a plurality of positioning systems are deployed.

It will be understand by a person of ordinary skill that the references herein to pluralities generally mean two or more, and do not necessarily include all members of a category. By way of example and not limitation, a reference to a “plurality of indoor positioning systems” means two or more indoor positioning systems, but does not necessarily mean all available positioning systems. If four indoor positioning systems are available but only three are functional, then the three functional systems may comprise the “plurality” of systems.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, shapes, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the disclosure.

1. A method comprising:
providing a user device;
providing a plurality of indoor positioning systems, each supplying a plurality of indoor positioning datasets, each of said indoor positioning datasets comprising indoor position data for a position of said user device in an indoor location;
receiving at said user device from each indoor positioning system said plurality of indoor positioning datasets supplied by said each indoor positioning system;
identifying a plurality of filtered positions by, for each of said indoor positioning systems, filtering said received plurality of indoor positioning datasets supplied by said each indoor positioning system to identify a filtered position for said user device, said filtered position being a determined highest quality available indoor position for said user device in said received plurality of indoor positioning datasets supplied by said each indoor positioning system; and
calculating a refined indoor position for said user device, said refined indoor position being calculated based at least in part based on said identified plurality of filtered positions.

2. The method of claim 1, wherein at least one indoor positioning system in said plurality of indoor positioning systems is selected from the group consisting of: a WiFi system, a global positioning system, a short-range low-energy beacon system, a visible light-based location system, an acoustic location system, and a magnetic field-based location system.

3. The method of claim 1, wherein said identifying step and said calculating step are performed at said user device.

4. The method of claim 1, further comprising:
providing a computer server;
receiving at said computer server said received pluralities of indoor positioning datasets supplied by said each indoor positioning system;
performing said identifying step and said calculating calculating step at said computer server;
receiving at said user device said refined indoor position.

5. The method of claim 1, wherein said user device is selected from the group consisting of: a mobile computer, a tablet computer, a laptop computer, a mobile phone, a smart phone, and a wearable computing device.

6. The method of claim 1, wherein said indoor position data for a user device includes one or more of: an altitude of said user device; an identifier of the floor of a building on which said user device is located; a timestamp indicative of when each said indoor position data was determined or received; direction, orientation, or heading data for said user device; an accuracy measure; and a signal strength indicator.

7. The method of claim 1, wherein said indoor position data includes a timestamp and said each filtered position in said plurality of filtered positions is determined at least in part based on comparing said timestamps to determine the most recent indoor position data for said each indoor positioning system.

8. The method of claim 1, wherein said indoor position data includes an accuracy measure and said each filtered position in said plurality of filtered positions is determined at least in part based on comparing said accuracy measures to determine a most accurate indoor position data for said each indoor positioning system.

9. The method of claim 1, wherein said refined indoor position is calculated in part based on historical accuracy data for each indoor positioning system in said plurality of indoor positioning systems.

10. A system comprising:
a user device comprising a microprocessor and a non-volatile computer-readable medium having computer-readable program instructions;
a plurality of indoor positioning systems, each supplying a plurality of indoor positioning datasets, each of said indoor positioning datasets comprising indoor position data for a position of said user device in an indoor location;
wherein said computer-readable program instructions, when executed by said microprocessor, cause the user device to perform the steps of:
receiving from each indoor positioning system said plurality of indoor positioning datasets supplied by said each indoor positioning system;
identifying a plurality of filtered positions by, for each of said indoor positioning systems, filtering said received plurality of indoor positioning datasets supplied by said each indoor positioning system to identify a filtered position for said user device, said filtered position being a determined highest quality available indoor position for said user device in said received plurality of indoor positioning datasets supplied by said each indoor positioning system; and
calculating a refined indoor position for said user device, said refined indoor position being calculated based at least in part based on said identified plurality of filtered positions.

11. The system of claim 10, wherein at least one indoor positioning system in said plurality of indoor positioning systems is selected from ale group consisting of: a WiFi system, a global positioning system, a short-range low-energy beacon system, a visible light-based location system, an acoustic location system, and a magnetic field-based location system.

12. The system of claim 10, wherein said user device is selected from the group consisting of a mobile computer, a tablet computer, a laptop computer, a mobile phone, a smart phone, and a wearable computing device.

13. The system of claim 10, wherein said indoor position data for a user device includes one or more of an altitude of said user device; an identifier of the floor of a building on which said user device is located; a timestamp indicative of when each said indoor position data was determined or received; direction, orientation, or heading data for said user device; an accuracy measure; and a signal strength indicator.

14. The system of claim 10, wherein said indoor position data includes a timestamp and said each filtered position in said plurality of filtered positions is determined at least in part based on comparing said timestamps to determine the most recent indoor position data for said each indoor positioning system.

15. The system of claim 10, wherein said indoor position data includes an accuracy measure and said each filtered position in said plurality of filtered positions is determined at least in part based on comparing said accuracy measures to determine a most accurate indoor position data for said each indoor positioning system.

16. The system of claim 10, wherein said refined indoor position is calculated in part based on historical accuracy data for each indoor positioning system in said plurality of indoor positioning systems.

17. A system comprising:
a computer server comprising a microprocessor and a non-volatile computer-readable medium having computer-readable program instructions;
a plurality of indoor positioning systems each supplying a plurality of indoor positioning datasets, each of said indoor positioning datasets comprising indoor position data for a position of a user device in an indoor location;
wherein said computer-readable program instructions, when executed by said microprocessor, cause the computer server to perform the steps of:
receiving via a telecommunications network a plurality of indoor positioning datasets supplied by each indoor positioning system;
identifying a plurality of filtered positions by, for each of said indoor positioning systems, filtering said received plurality of indoor positioning datasets supplied by said each indoor positioning system to identify a filtered position for said user device, said filtered position being a determined highest quality available indoor position for said user device in said received plurality of indoor positioning datasets supplied by said each indoor positioning system; and
calculating a refined indoor position for said user device, said refined indoor position being calculated based at least in part based on said identified plurality of filtered positions.

18. The system of claim 17, wherein said indoor position data includes a timestamp and said each filtered position in said plurality of filtered positions is determined at least in part based on comparing said timestamps to determine the most recent indoor position data for said each indoor positioning system.

19. The system of claim 18, wherein said indoor position data includes an accuracy measure and said each filtered position in said plurality of filtered positions is determined at least in part based on comparing said accuracy measures to determine a most accurate indoor position data for said each indoor positioning system.

20. The method of claim 1, wherein said refined indoor position is calculated in part based on historical accuracy data for each indoor positioning system in said plurality of indoor positioning systems.
